(19) United States
(12) Patent Application Publication
(10) Pub. No.: US 2002/0074014 A1
(43) Pub. Date: Jun. 20, 2002

(54) Method for cleaning a metal etching chamber

(76) Inventors: Mao-Chang Yeh, Shrlin Chiu (TW); Ta Chin Chen, Junghe City (TW); Chen Lung Fan, Hsinchu (TW); Kai Chin Chang, Shinyi Chiu (TW); Jing Kae Liu, Jui-Fang (TW)

Correspondence Address: LAM RESEARCH CORPORATION, 4650 CUSHING PARKWAY CA-1, FREMONT, CA, 94538, US

(21) Appl. No.: 09/916,702

(22) Filed: Jul. 26, 2001

(30) Foreign Application Priority Data
Oct. 26, 2000 (TW) 089121588

(51) Int. Cl. B08B 7/04; B08B 9/08

(52) U.S. Cl. 134/1.1; 134/22.18; 134/30

(57) ABSTRACT

The present invention relates to a method for cleaning a metal etching chamber. The method is accomplished by using waterless auto cleaning first, followed by an Argon clean. The waterless auto cleaning process comprises two steps. First, oxygen plasma is used to eliminate the byproducts produced from the side reaction with photo resistant in the etching reaction. Second, chlorine plasma is used to eliminate the byproducts produced from the side reaction with a metal thin film under a photo resistant and the residual oxygen of the previous step. The Argon clean can further eliminate the residual chlorine of the previous step and the products produced in the chemical reaction during the process of waterless auto clean.

### CROSS REFERENCE TO RELATED APPLICATIONS

This application claims priority from prior foreign Taiwanese Application Patent No. 089121588 filed Oct. 16, 2000 and entitled “Method for Cleaning a Metal Etching Chamber.” In support of this claim, enclosed is a certified copy of said prior foreign application.

### BACKGROUND OF THE INVENTION

1. Field of the Invention

The present invention relates to a method for cleaning a metal etching chamber, and more particularly, to a method for maintaining the best status of a metal etching chamber during the manufacturing process of a semiconductor.

2. Description of the Related Art

The waferless autoclean (WAC) method of the present invention is a refinement of the conventional dry clean technique, and comprises a two stage waterless auto cleaning step and an Argon purge step.

Many etching reactions in etching chambers create byproducts which deposit on the surface of the chamber wall. The occurrence of deposition of byproducts is most pronounced during a metal etching process. As wafers are etched in the chamber sequentially, the deposition on the surface of the chamber wall gradually increases. When the amount of deposition reaches a certain level, the deposition peels off and contaminates the wafer due to a sudden increase of particles. A wet clean process is then needed to remove this deposition. A plasma clean method which removes the deposition periodically, would reduce the amount of deposition particles and mean time between wet cleans (MTBC) would be increased. Using a plasma clean frequently is a proven way to increase the mean time between wet cleans and reduce particle deposition.

Conventional etching chambers are cleaned by the wet clean method illustrated in FIG. 1, when the byproducts deposited on the surface of the chamber wall reach a certain level. As mentioned above, when byproducts deposited on the surface of the chamber wall reach a certain level, the deposition may peel off before wet clean, increasing the particle count in the chamber, and thereby contaminate wafers. Additionally, flaked byproducts could fall on the wafer chuck and compromise the wafer cooling system. Moreover, conventional etching chambers require adjustment by a photo resist dummy wafer to return to a normal condition after the chamber is idle for over two hours or if the chamber has undergone a wet clean. This type of clean and adjustment has the following disadvantages:

(1) The engineer or operator must stop the production to perform the wet clean and adjustment. The stoppage increases tool down time and throughput.

(2) The use of the photo resist wafer for adjustment will increase the job loading on a photo module which provides the photo resist wafers and increase the cost of wafers.

Accordingly, the present invention relates to a new process that can clean the etching chamber with a plasma clean between two wet cleans. To overcome the disadvantages mentioned above, the present invention provides an etching chamber cleaning method that is automatic, does not require dummy wafers, and greatly extends mean time between wet cleans.

### SUMMARY OF THE INVENTION

The present invention provides a metal etching chamber cleaning method that obviates stoppage by an operator.

The present invention also provides a metal etching chamber cleaning method that reduces tool down and monitor time; that is to say, it can increase tool usage, uptime, and throughput.

The present invention also provides a metal etching chamber cleaning method that does not require chamber seasoning and adjustment wafers, reduces the usage of dummy wafers, reduces wafer cost, and reduces job loading on the photo module.

The present invention provides a metal etching chamber cleaning method that increases mean time between wet cleans from 5000 RF min to 20000 RF min (RF min is the time of radio frequency, (“R.F.”) operation representing plasma operating time).

To overcome the disadvantages of prior art and achieve the purposes mentioned above, the present invention provides a metal etching chamber cleaning method. The method is an automated waterless plasma cleaning method that can be set to run automatically at predetermined intervals set by the process and comprised of the following three steps. First, an oxygen plasma is used to eliminate the byproducts produced by the side reaction with a photo resistant in the etching reaction. Secondly, a chlorine plasma is used to eliminate byproducts produced by the side reaction with a metal thin film under a photo resistant and the residual oxygen of the previous step. Finally, an Argon purge is used to further eliminate the residual chlorine of the previous step as well as products produced in the chemical reaction during the process of waterless auto cleaning.

### BRIEF DESCRIPTION OF THE DRAWINGS

The present invention will now be described by way of example with reference to the accompanying drawings wherein:

FIG. 1 is a flow chart of a conventional wet cleaning and seasoning process;

FIG. 2 is a flow chart of a conventional seasoning process after a chamber has idled for over two hours;

FIG. 3 is a flow chart of a waterless auto cleaning method of the present invention;

FIG. 4 shows an endpoint trace of the waterless auto cleaning method of the present invention;

FIG. 5 shows an endpoint trace without using the waterless auto cleaning method;

FIG. 6 shows an endpoint trace after processing waterless auto cleaning of the present invention after etching 100 wafers;

FIG. 7 is a picture of byproducts deposited on the surface of coupon fixed on the wall of a chamber without using the waterless auto cleaning method of the present invention;

FIG. 8 is a picture of the surface of coupon fixed on the wall of a chamber that has been cleaned by waterless auto cleaning method; and

FIG. 9 is a graph showing the number of contaminated dies with and without waterless auto cleaning.

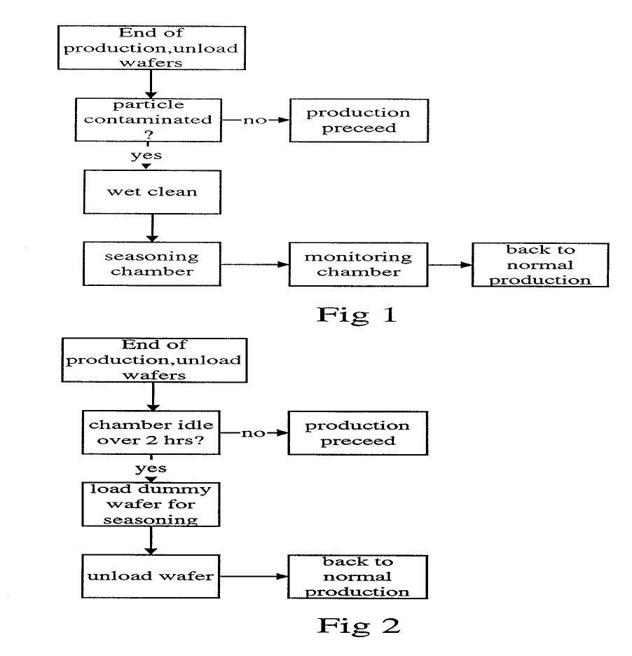

### DETAILED DESCRIPTION OF THE PREFERRED EMBODIMENTS

The metal etching chamber cleaning method of the present invention is a method that can effectively increase mean time between wet clean and prevent high particle counts in the etching chamber. The method of the present invention is different from the conventional wet cleaning method that used by an engineer or operators to operate the dummy wafer.

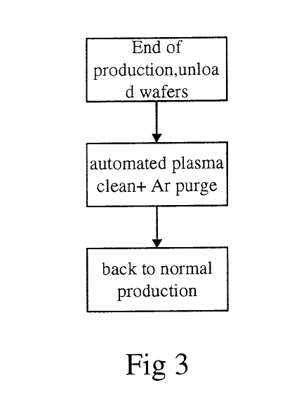

The method of the present invention is comprised of three steps illustrated in FIG. 3, wherein two steps of waferless auto cleaning and subsequent Argon purge are included.

1. Chemical composition of the waterless auto clean:

The recipe of the present invention is aimed at rapidly and effectively cleaning the etching chamber. Since an ordinary etching chamber is not activated by radio frequency power, that is to say the chamber receives little bias power during processing, it is very likely to produce deposition. The deposition on the chamber wall must be removed by an isotropic etching method, which necessitates the need for oxygen and chlorine plasma cleaning. For all applications in the reaction chambers, the recommended recipes of the present invention that can remove all the deposition on the chamber wall effectively are described below. Among them, oxygen plasma can eliminate carbon-based deposition that is mostly produced from photo resist, while chlorine plasma can eliminate aluminum-based deposition which is mostly produced from etching Aluminum thin film.

The recipes disclosed by the present invention is listed as follows:

(1) Oxygen Plasma

Pressure: 10˜80 m torr

400˜2000 watt TCP

50˜0 watt bottom power

100˜500 s.c.c.m. O₂

Time: 10˜60 sec

(2) Chlorine Plasma

Pressure: 10˜80 m torr

400˜2000 watt TCP

50˜0 watt bottom power

100˜500 s.c.c.m. Cl₂

Time: 10˜60 sec

The above composition could be used safely without any wafer in the chamber. It should be noted that high bottom power should never be used in conjunction with a waferless autoclean. To do so could damage the HAA or ceramic electrostatic chuck. In some applications, the above composition may need to be slightly modified to optimize cleaning efficiency.

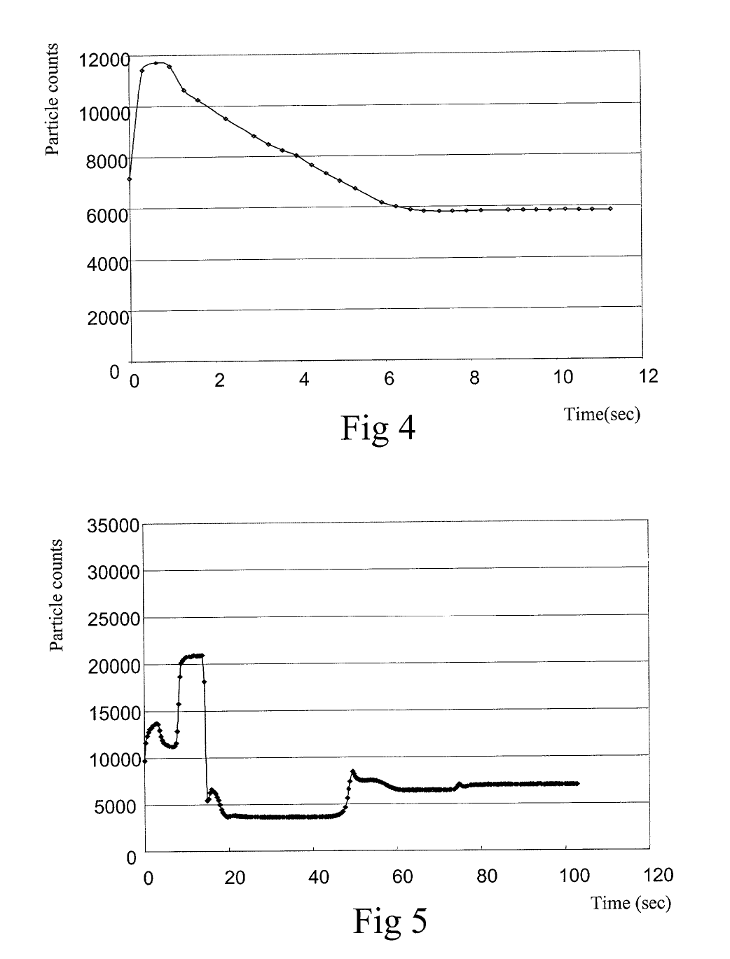

The duration of the Waferless Auto Clean (WAC) will be determined by the application with which it will be used. The time which the WAC takes to remove the deposition deposited on the surface of the chamber will vary with the film thickness and compound used for etching the deposition. The time needed for cleaning a chamber completely can be estimated from endpoint signals derived from using endpoint wavelengths monitored on the system. The 703 nm endpoint traces show a gradually decreasing intensity that flattens out when the chamber is completely clean, as shown in FIG. 4. The observed wavelength intensity decreases due to non-uniform deposition during production and non-uniform removal of byproducts during WAC.

The endpoint traces above are taken from one of the WAC processes in which CHF₃Cl₂Ar is used for etching an ARC layer, and Cl₂BCl₃CHF₃, Cl₂BCl₃N₂, or Cl₂BCl₃ is used as the main etching agent for etching an Al—Cu layer. A rough indication that a chamber has been cleaned is when flat endpoint traces in an O₂ plasma cleaning step are observed.

2. Argon Purge:

The oxygen plasma clean and chlorine plasma clean of waterless auto cleaning mentioned above cannot completely remove all the byproducts if a chamber has been operated for a long time. If the chamber has been operated for a long time, the oxygen plasma clean and chlorine plasma clean only removes the byproducts from the production process, but not byproducts from the WAC process. To thoroughly remove the byproducts, the present invention performs an Ar purge step after the WAC. The recommended Ar purge recipe is listed below.

Pressure: 0˜10 m torr

0˜300 s.c.c.m. Ar

Time: 5˜30 sec

The main purpose of the Ar purge is to remove byproducts produced from the WAC process. In oxygen and chlorine WAC steps, oxygen ions and chlorine ions will react with the byproducts deposited on the chamber wall, and this will lead to some products generated from the reaction. Removing these products immediately is necessary for preventing the products from simply re-depositing on the chamber wall. The best way to obtain an optimal recipe of Ar purge step is to detect repeatedly the situation of deposition being removed in the chamber under different pressures.

3. Process Shift Check:

Regardless of what steps are taken to improve the uptime and mean time between wet clean, the most important thing for production Fabs is process stability. Etching rate, etching uniformity, and critical dimension (CD) bias are three main indexes to evaluate process stability. The present invention monitors all the process indexes. The data show no process shift except for a 6% faster Al—Cu etching rate. Table 1 shows the etching rate differences of Al—Cu etching.

TABLE 1
Al-Cu Etch Rate “ER” differences

| | Without WAC | With WAC |
|---|---|---|
| First ER wafer | 10358 | 10008 |
| 50^{th} ER wafer | 10318 | 11526 |
| 100^{th} ER wafer | 10399 | 11082 |
| Mean | 10399 | 11082 |

Unit: Å min

Table 2 shows the Al—Cu etching uniformity data. The data shows consistency under the condition with or without WAC.

TABLE 2
Al-Cu etching uniformity

| | Without WAC | With WAC |
|---|---|---|
| First ER wafer | 6.4 | 5.9 |
| 50^{th} ER wafer | 6.4 | 4.3 |
| 100^{th} ER wafer | 5.9 | 5.0 |
| Mean | 6.2 | 5.1 |

Unit

Table 3 shows that the CD bias will not be affected by the implementation of WAC.

TABLE 3

| | Without WAC | With WAC |
|---|---|---|
| 100^{th} ER wafer | +0.0076 | +0.01 |

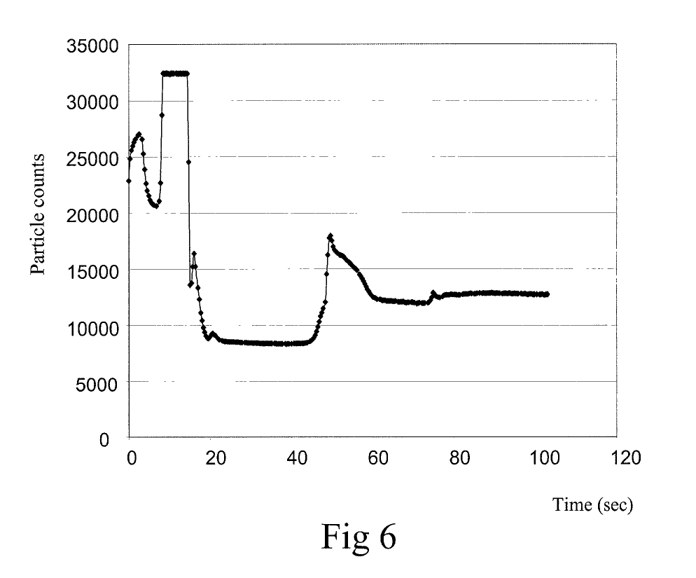

FIG. 5 and FIG. 6 show etching process endpoint curves make no difference in the processes with or without WAC.

4. Inspection of the Chamber Wall:

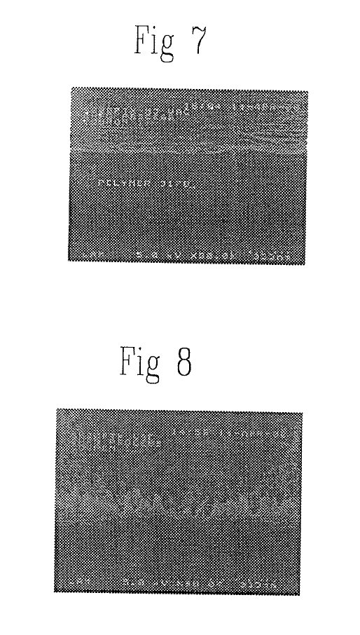

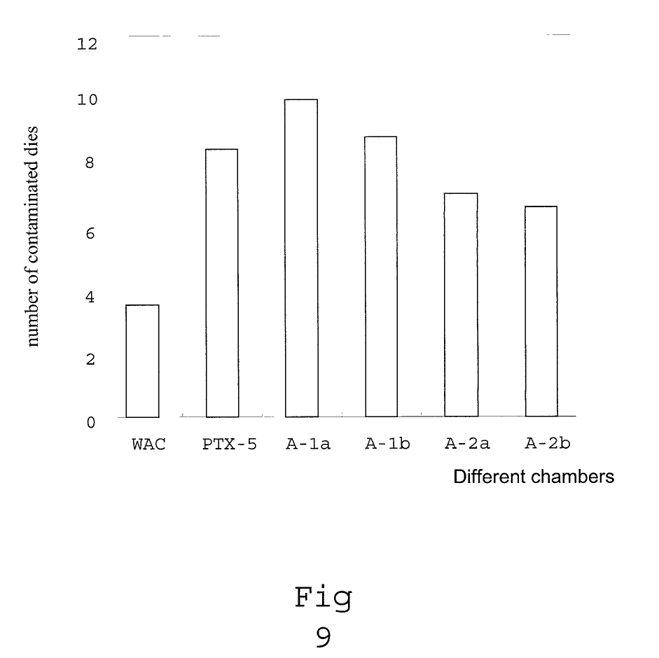

The differences on chamber walls which undergo or do not undergo WAC will now be described. First, a thermal oxide wafer to obtain a wafer of 1 cm by 3 cm as a coupon is cut. This coupon is fixed on the chamber wall. After the coupon is tested, it is removed from the chamber wall and is examined by SEM or EDS. FIG. 7 and FIG. 8 show differences in the coupons on the chamber wall without WAC and with WAC, respectively.

Coupons fixed on the chamber wall of the chamber and are not exposed to WAC are examined by EDS to understand the composition of its deposition. As a result, there are five elements, Si, O, C, Al, and Cl. Since Si and O are the elements originated from the coupons, C, Al, and Cl must be the elements of byproducts of the reaction. Only Si and O are found on the coupons fixed on chamber walls which have undergone WAC. This proves that all byproducts are completely removed by WAC. This test reflects that the implementation of WAC can effectively remove all byproducts deposited on the chamber wall.

5. Mean-time Between Cleans “MTBC” and Uptime Improvement:

Many etching applications on etchers cause the deposition of etching byproducts on the surface of chamber wall. Frequent and periodical use of waferless plasma clean can reduce particle counts and keeps the chamber clean before the chamber wall became heavily deposited with etching byproducts. Moreover, the present invention can increase MTBC greatly from 5000 RF min to 20000 RF min. Frequent waterless auto cleaning effectively removes deposition, reduces particle counts and increases MTBC.

Instead of the conventional wet clean, the present invention does not require engineer or operator production interrupt, open chamber clean, and seasoning wafers, thereby increasing machine uptime. The WAC process can be performed automatically by the program control, and thus can reduce the operation time of an engineer or operator associated with loading and unloading wafers. This will greatly increase the uptime of machine, and throughput will not be affected by requiring the chamber adjustment.

The waferless plasma clean of the present invention improves the uptime more than 10%, because no seasoning wafers are necessary to be used and time for loading and unloading dummy wafers is saved.

6. The Improvement on Yield:

Particle counts and contamination caused by the particles become more serious as die size is increased. One particle could damage one die and one die loss will reduce the yield by 2.5% in a 40-die wafer. FIG. 9 shows that the average number of contaminated dies are in the range of 6.58˜10 if the chamber does not undergo WAC. In contrast, the chamber that undergoes WAC has a number of contaminated dies of 3.58 and a higher yield of 7.5%.

7. Mix Run Products:

Chamber condition stability for etching becomes a critical issue as the critical dimension (CD) is lowered to 0.25 μm and below. By the implementation of WAC, the chamber condition will return to the original clean condition. When the next wafer is transferred to the chamber, it is exposed to the same clean chamber condition as the previous wafer. Regardless of how dirty the wafer process is, the present invention can effectively mix different batches of wafers of different applications if a WAC is implemented.

The technical contents and features of the present invention are disclosed above, but anyone that is familiar with the technique could possibly make modify or change the details in accordance with the present invention without departing from the technologic ideas and spirit of the invention.

The protection scope of the present invention shall not be limited to what embodiment discloses, it should include various modification and changes that are made without departing from the technologic ideas and spirit of the invention, and should be covered by the claims below.

What is claimed is:

1. A method for cleaning a metal etching chamber, comprising:
performing a waferless auto cleaning, to remove the deposition on etching chamber walls; and
performing Ar purge, to further remove residual deposition in the chamber.

2. The method according to claim 1, further comprising:
performing oxygen plasma cleaning, to remove C-based deposition; and
performing chlorine plasma cleaning, to remove Al-based deposition.

3. The method according to claim 2, in which the oxygen plasma cleaning is performed between pressures of 10 to 80 mT, 400 to 2000 watt TCP, 50 to 0 watt bottom power and 100 to 500 s.e.c.m. oxygen for 10 to 60 seconds.

4. The method according to claim 2, in which the chlorine plasma clean is performed between pressures of 10 to 80 mT, 400 to 2000 watt TCP, 5Oto 0 watt bottom power and 100 to 500 s.c.c.m. chlorine for 10 to 60 seconds.

5. The method according to claim 1, wherein the Ar purge is performed under pressure of 0 to 10 mT, 0 to 300 s.c.c.m. Argon for 5 to 30 seconds.
